(19) United States
(12) Patent Application Publication
(10) Pub. No.: US 2021/0158763 A1
(43) Pub. Date: May 27, 2021

(54) LIGHT-EMITTING DIODE APPARATUS AND CONTROL METHOD THEREOF

(71) Applicant: Au Optronics Corporation, Hsinchu (TW)

(72) Inventor: Sen-Chuan Hung, Hsinchu (TW)

(73) Assignee: Au Optronics Corporation, Hsinchu (TW)

(21) Appl. No.: 16/889,776

(22) Filed: Jun. 1, 2020

(30) Foreign Application Priority Data
Nov. 25, 2019 (TW) 108142668

(51) Int. Cl. G09G 3/3291

(52) U.S. Cl. CPC G09G 3/3291; G09G 2310/0272; G09G 2310/061

(57) ABSTRACT

A light-emitting diode apparatus and a control method are provided. The control method includes: a voltage level of a second terminal of a driving transistor is pulled down via a voltage regulator according to a light-emitting control signal and a voltage control signal in a pre-reset phase to increase a voltage difference between a first terminal and the second terminal of the driving transistor; a control terminal of the driving transistor is reset by receiving a reset voltage in a first reset phase; the control terminal of the driving transistor is compensated to a compensation voltage in a compensation phase; and the driving transistor provides a driving current in a light emission phase to drive a light-emitting diode to emit a light.

### CROSS-REFERENCE TO RELATED APPLICATION

This application claims the priority benefit of Taiwan patent application serial no. 108142668, filed on Nov. 25, 2019. The entirety of the above-mentioned patent application is hereby incorporated by reference here and made a part of this specification.

### BACKGROUND OF THE INVENTION

### Field of the Invention

The invention relates to a light-emitting diode apparatus and a control method of the light-emitting diode apparatus.

### Description of Related Art

With the advancement of display techniques, light-emitting diodes have been widely used in display technology, and the active-matrix organic light-emitting diode (AMOLED) is one of the main development focuses of display techniques.

However, when the AMOLED is operated at high speed and when the display screen is switched, display situations of motion blur and insufficient response time usually occur, so that some afterimages are present in the screen switch process, thus causing the overall display quality to be affected. Therefore, how to effectively improve or alleviate the display situation of afterimages of the screen via a suitable control method and further improve the response time of the screen switch to improve the overall display quality is an important subject for those skilled in the art.

### SUMMARY OF THE INVENTION

The invention provides a light-emitting diode apparatus and a control method of the light-emitting diode apparatus that may effectively alleviate dynamic blurring of the screen and improve the response time of screen switch.

A control method of the light-emitting diode apparatus of the invention includes: a voltage level of a second terminal of a driving transistor is pulled down via a voltage regulator according to a light-emitting control signal and a voltage control signal in a pre-reset phase to increase a voltage difference between a first terminal and the second terminal of the driving transistor; a control terminal of the driving transistor is reset by receiving a reset voltage in a first reset phase; the control terminal of the driving transistor is compensated to a compensation voltage in a compensation phase; and the driving transistor provides a driving current in a light emission phase to drive a light-emitting diode to emit a light.

A light-emitting diode apparatus of the invention includes a driving transistor, a voltage regulator, and a light-emitting diode. A first terminal of the driving transistor receives a system high voltage. The voltage regulator is coupled to a second terminal of the driving transistor. A first terminal of the light-emitting diode is coupled to the voltage regulator, and a second terminal of the light-emitting diode receives a system low voltage. The voltage regulator pulls down a voltage level of the second terminal of the driving transistor according to a light-emitting control signal and a voltage control signal in a pre-reset phase to increase a voltage difference between a first terminal and the second terminal of the driving transistor. A control terminal of the driving transistor receives a reset voltage in a first reset phase to reset the control terminal of the driving transistor. The control terminal of the driving transistor is compensated to a compensation potential in a compensation phase. A driving current is provided via the driving transistor in a light-emitting phase to drive the light-emitting diode to emit a light.

A control method of a light-emitting diode apparatus of the invention includes: a voltage level of a second terminal of a driving transistor is pulled down via a voltage regulator according to a first control signal in a reset phase to increase a voltage difference between a first terminal and the second terminal of the driving transistor; a data voltage is generated to a control terminal of the driving transistor via the voltage generator according to the first control signal or a second control signal in a data writing phase to perform a data writing on the driving transistor; and a driving current is provided via the driving transistor in a light-emitting phase to drive a light-emitting diode to emit a light.

A light-emitting diode apparatus of the invention includes a driving transistor, a voltage regulator, a light-emitting diode, and a voltage generator. A first terminal of the driving transistor receives a system voltage source. The voltage regulator is coupled to a second terminal of the driving transistor. A first terminal of the light-emitting diode is coupled to the voltage regulator, and a second terminal of the light-emitting diode receives a system low voltage. The voltage generator is coupled to a control terminal and the first terminal of the driving transistor. The voltage regulator pulls down a voltage level of the second terminal of the driving transistor according to a first control signal in a reset phase to increase a voltage difference between the first terminal and the second terminal of the driving transistor. The voltage generator generates a data voltage to the control terminal of the driving transistor according to the first control signal or a second control signal in a data writing phase to perform a data writing on the driving transistor. The driving transistor provides a driving current in a light-emitting phase to drive the light-emitting diode to emit a light.

Based on the above, in the light-emitting diode apparatus of the invention, an operating action of a pre-reset phase may be added before the first reset phase is performed. In the pre-reset phase, the light-emitting diode apparatus may pull down the voltage level of the second terminal (i.e., the drain terminal) of the driving transistor in advance via the voltage regulator, thereby increasing the voltage difference between the first terminal (i.e., the source terminal) and the second terminal of the driving transistor. When the light-emitting diode apparatus is operated in the light-emitting phase, the current magnitude of the driving current may be effectively increased, thereby alleviating the dynamic afterimage situation of the light-emitting diode apparatus and improving the response time of the light-emitting diode apparatus so as to improve the overall display quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of the coupling of a light-emitting diode, a voltage regulator, and a driving transistor shown according to an embodiment of the invention.

FIG. 2 is a flowchart of a control method of a light-emitting diode apparatus shown according to an embodiment of the invention.

FIG. 3A to FIG. 3G are control diagrams of a light-emitting diode apparatus shown according to an embodiment of the invention.

FIG. 4 is a diagram of a control waveform shown according to an embodiment corresponding to FIG. 3A to FIG. 3G.

FIG. 5 is a diagram of a control waveform shown according to another embodiment corresponding to FIG. 3A to FIG. 3G.

FIG. 6 is a diagram of the coupling of a light-emitting diode, a voltage regulator, a voltage generator, and a driving transistor shown according to another embodiment of the invention.

FIG. 7 is a flowchart of a control method of a light-emitting diode apparatus shown according to another embodiment of the invention.

FIG. 8A to FIG. 8C are control diagrams of a light-emitting diode apparatus shown according to the first embodiment shown in FIG. 6 of the invention.

FIG. 9 is a diagram of a control waveform shown according to an embodiment corresponding to FIG. 8A to FIG. 8C.

FIG. 10A to FIG. 10C are control diagrams of a light-emitting diode apparatus shown according to the second embodiment shown in FIG. 6 of the invention.

FIG. 11 is a diagram of a control waveform shown according to an embodiment corresponding to FIG. 10A to FIG. 10C.

FIG. 12A to FIG. 12D are control diagrams of a light-emitting diode apparatus shown according to the third embodiment shown in FIG. 6 of the invention.

FIG. 13 is a diagram of a control waveform shown according to an embodiment corresponding to FIG. 12A to FIG. 12D.

### DESCRIPTION OF THE EMBODIMENTS

The term “coupled to (or connected to)” used in the entire text of the specification of the present application (including claims) may refer to any direct or indirect connecting means. For instance, if the text describes a first device is coupled to (or connected to) a second device, then it should be understood that the first device may be directly connected to the second device, or the first device may be indirectly connected to the second device via other devices or certain connecting means. Moreover, when applicable, devices/components/steps having the same reference numerals in figures and embodiments represent the same or similar parts. Elements/components/steps having the same reference numerals or having the same terminology in different embodiments may be cross-referenced.

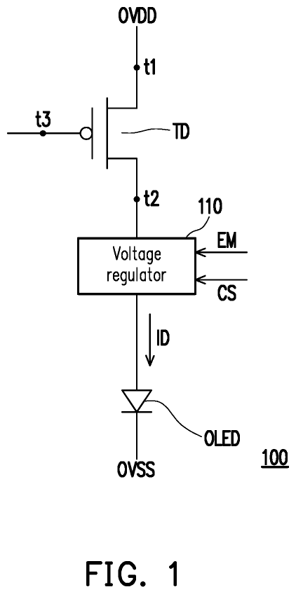

FIG. 1 is a diagram of the coupling of a light-emitting diode, a voltage regulator, and a driving transistor shown according to an embodiment of the invention. Please refer to FIG. 1. In the present embodiment, a light-emitting diode apparatus 100 includes a driving transistor TD, a voltage regulator 110, and a light-emitting diode OLED. The driving transistor TD has a first terminal t1 (for example, a source terminal), a second terminal t2 (for example, a drain terminal), and a control terminal t3 (for example, a gate terminal). The first terminal t1 of the driving transistor TD may receive a system high voltage OVDD. The voltage regulator 110 is coupled to the second terminal t2 of the driving transistor TD. The first terminal (for example, an anode terminal) of the light-emitting diode OLED is coupled to the voltage regulator 110, and the second terminal (for example, a cathode terminal) of the light-emitting diode OLED receives a system low voltage OVSS.

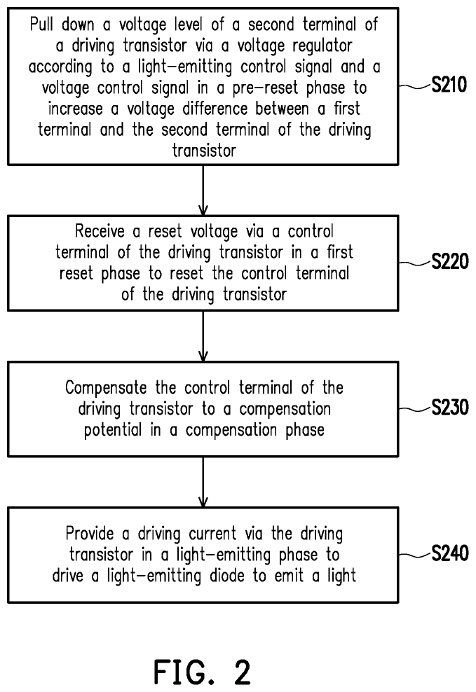

FIG. 2 is a flowchart of a control method of a light-emitting diode apparatus shown according to an embodiment of the invention. Please refer to FIG. 1 and FIG. 2 at the same time. In step S210, when the light-emitting diode apparatus 100 is operated in a pre-reset phase, the light-emitting diode apparatus 100 may pull down the voltage level of the second terminal t2 of the driving transistor TD via the voltage regulator 110 according to a light-emitting control signal EM and a voltage control signal CS.

For example, in the pre-reset phase, the voltage control signal CS of the present embodiment may be set to an enabled (for example, a low voltage level) state. In this case, the voltage regulator 110 may pull down the voltage level of the second terminal t2 of the driving transistor TD according to the voltage control signal CS having a low voltage level, so that the voltage difference between the first terminal t1 and the second terminals t2 of the driving transistor TD may be increased.

In step S220, when the light-emitting diode apparatus 100 is operated in a first reset phase, the light-emitting diode apparatus 100 may reset the control terminal t3 of the driving transistor TD using a reset voltage. In step S230, when the light-emitting diode apparatus 100 is operated in a compensation phase, the light-emitting diode apparatus 100 may cause the control terminal t3 of the driving transistor TD to be compensated to a compensation potential to compensate the voltage at the control terminal t3 of the transistor TD. In step S240, when the light-emitting diode apparatus 100 is operated in a light-emitting phase, the driving transistor TD may provide a driving current ID to the light-emitting diode OLED to drive the light-emitting diode OLED to emit a light.

It is worth mentioning that since the voltage regulator 110 of the present embodiment pulls down the voltage level of the second terminal t2 of the driving transistor TD in advance in the pre-reset phase to increase the voltage difference between the first terminal t1 and the second terminal t2 of the driving transistor TD, when the voltage difference between the first terminal t1 and the second terminal t2 of the driving transistor TD is increased, and when the light-emitting diode apparatus 100 is operated in the light-emitting phase, the driving transistor TD may provide a relatively large driving current ID to light up the light-emitting diode OLED.

In other words, the control method of the present embodiment includes adding the operating action of the pre-reset phase before the light-emitting diode apparatus 100 is operated in the first reset phase. In the pre-reset phase, the light-emitting diode apparatus 100 may pull down the voltage level of the second terminal t2 of the driving transistor TD in advance via the voltage regulator 110, thereby increasing the voltage difference between the first terminal t1 and the second terminal t2 of the driving transistor TD. As a result, when the light-emitting diode apparatus 100 is operated in the light-emitting phase, the current magnitude of the driving current ID may be effectively increased, thereby alleviating the dynamic afterimage situation of the light-emitting diode apparatus 100 and improving the response time of the light-emitting diode apparatus 100 so as to improve the overall display quality.

It should be noted that, in the control method shown in FIG. 2, the light-emitting diode apparatus 100 of the present embodiment sequentially performs the operating actions of steps S210, S220, S230, and S240. However, under some design requirements, the operating action of S220 may be completed before step S210. That is, under some design requirements, the pre-reset phase (step S210) may occur after the first reset phase (step S220), the compensation phase (step S230) may occur after the pre-reset phase, and the light-emitting phase (step S240) may occur after the compensation phase.

In addition, under other design requirements, a second reset phase may be included between the compensation phase (step S230) and the light-emitting phase (step S240). In the second reset phase, the light-emitting diode apparatus 100 may perform the operating action of step S210 again, so that the voltage regulator 110 may pull down the voltage level of the second terminal t2 of the driving transistor TD again and the voltage difference between the first terminal t1 and the second terminal t2 of the driving transistor TD may be further increased. As a result, the current magnitude of the driving current ID may be further increased in the light-emitting phase.

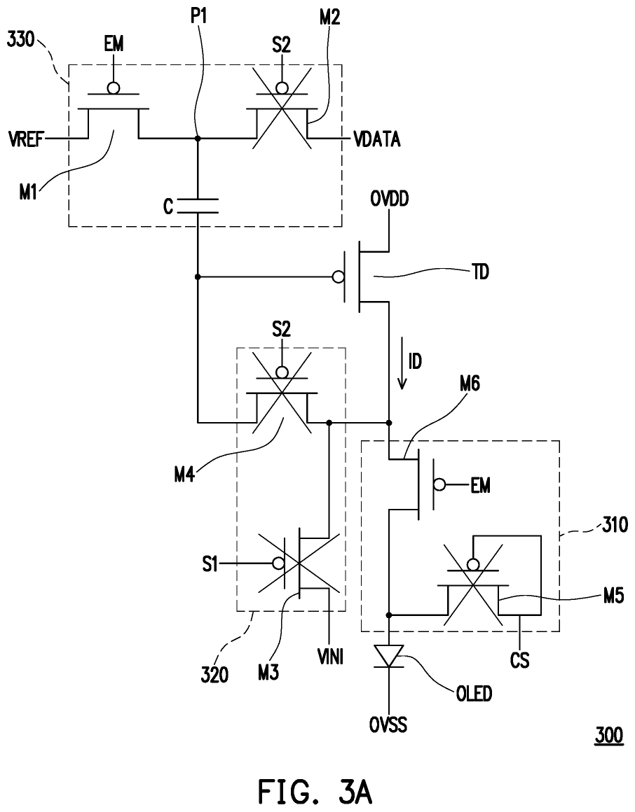

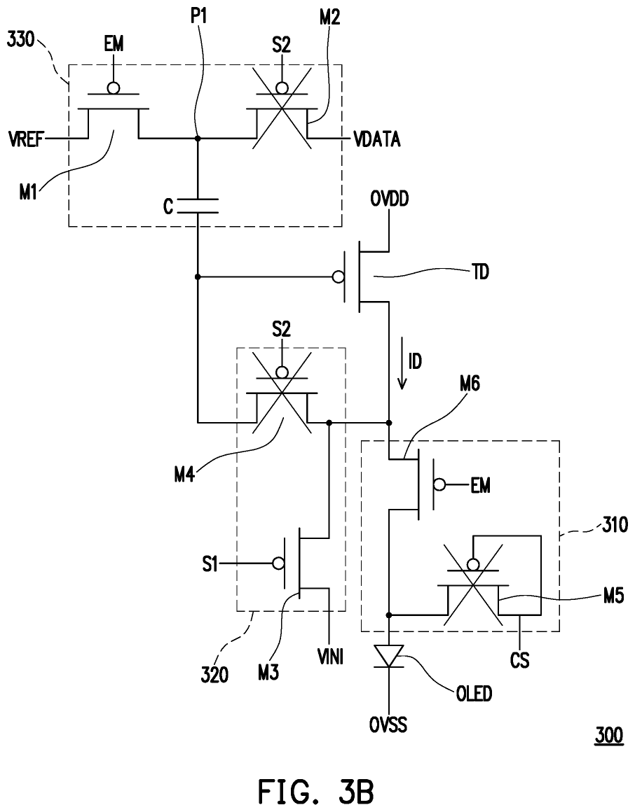

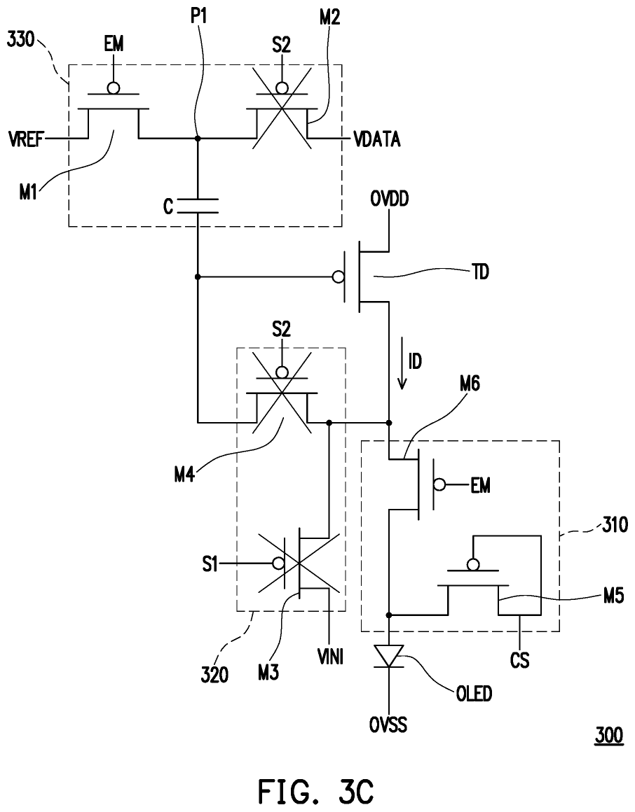

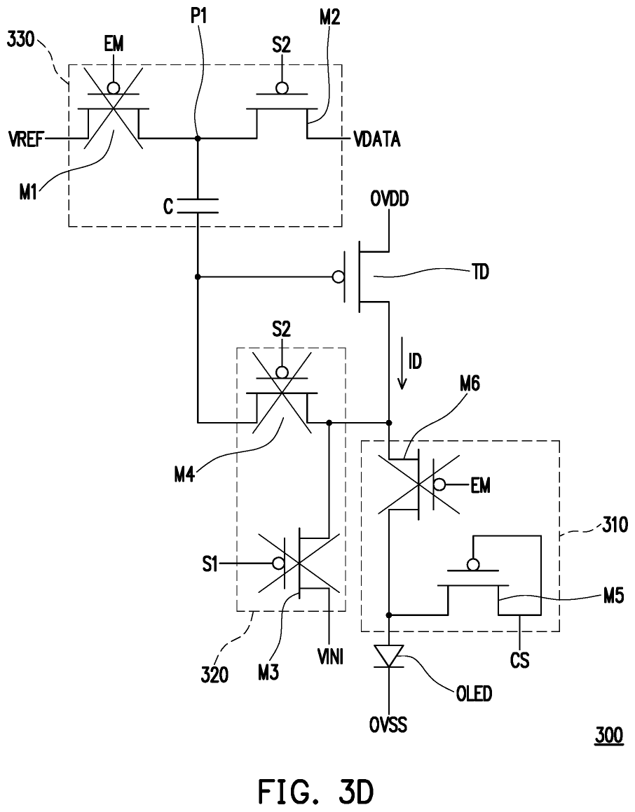

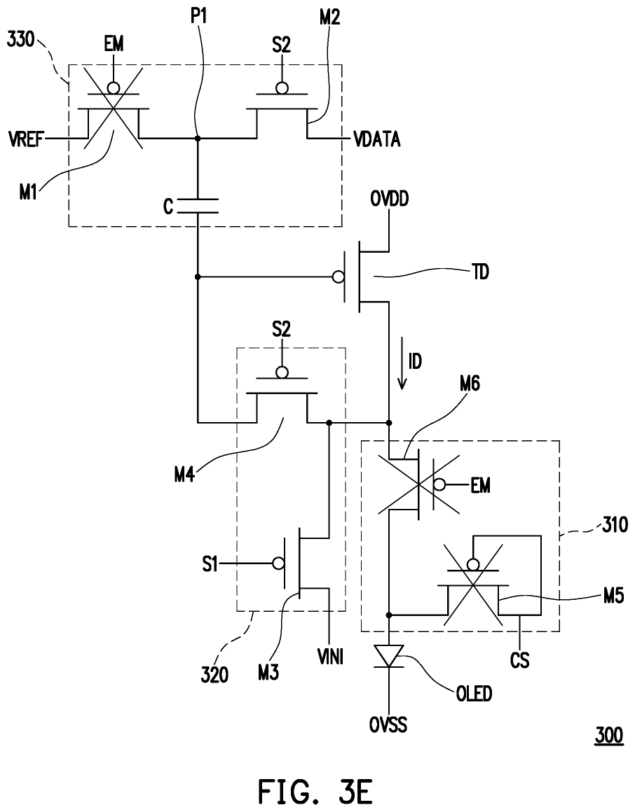

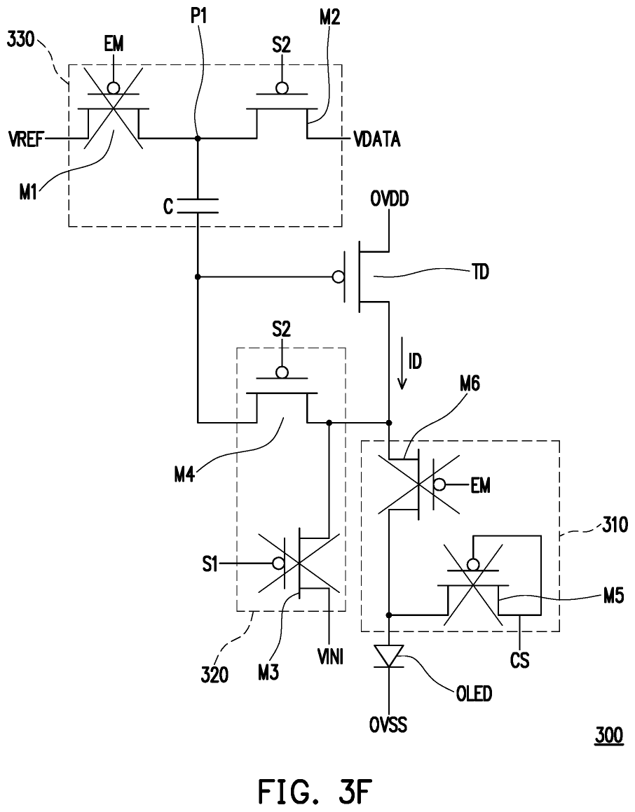

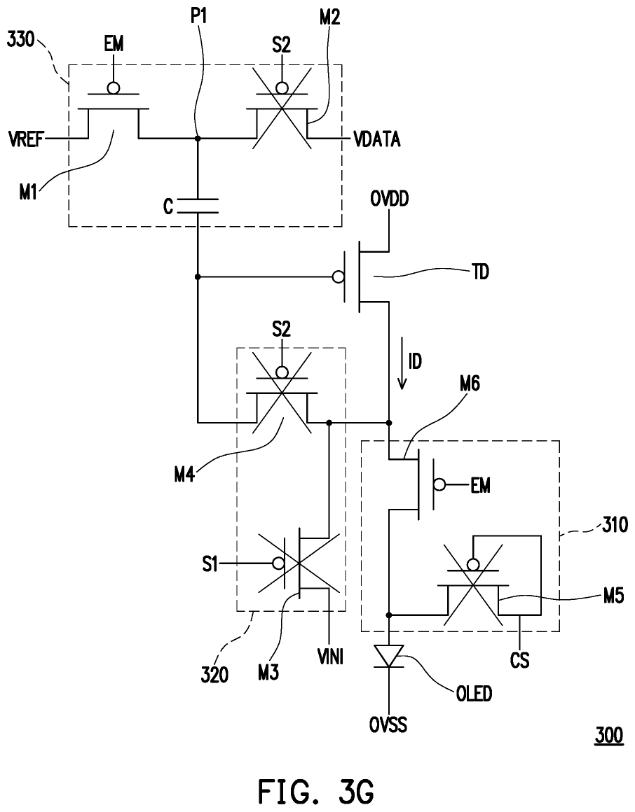

FIG. 3A to FIG. 3G are control diagrams of a light-emitting diode apparatus shown according to an embodiment of the invention. In the present embodiment, a light-emitting diode apparatus 300 includes the driving transistor TD, a voltage regulator 310, a first voltage generator 320, a second voltage generator 330, and the light-emitting diode OLED.

The voltage regulator 310 is coupled to the second terminal of the driving transistor TD and the first terminal of the light-emitting diode OLED. In particular, the voltage regulator 310 includes a switch M5 and a switch M6. The first terminal and the control terminal of the switch M5 are coupled to each other and receive the voltage control signal CS together. The second terminal of the switch M5 is coupled to the first terminal of the light-emitting diode OLED. The first terminal of the switch M6 is coupled to the first terminal of the light-emitting diode OLED, the second terminal of the switch M6 is coupled to the second terminal of the driving transistor TD, and the control terminal of the switch M6 receives the light-emitting control signal EM.

The first voltage generator 320 is coupled between the control terminal of the driving transistor TD and the voltage regulator 310. In particular, the first voltage generator 320 includes the switch M3 and the switch M4. The first terminal of the switch M3 receives a reset voltage VINI, and the control terminal of the switch M3 receives a first control signal S1. The first terminal of the switch M4 is coupled to the second terminal of the switch M3 and the second terminal of the transistor M6. The second terminal of the switch M4 is coupled to the control terminal of the driving transistor TD. The control terminal of the switch M4 receives a second control signal S2.

The second voltage generator 330 is coupled to the control terminal of the driving transistor TD. In particular, the second voltage generator 330 includes the switch M1, the switch M2, and a capacitor C. The first terminal of the switch M1 receives a reference voltage VREF, the second terminal of the switch M1 is coupled to a node P1, and the control terminal of the switch M1 receives the light-emitting control signal EM. The first terminal of the switch M2 receives a data voltage VDATA, the second terminal of the switch M2 is coupled to the node P1, and the control terminal of the switch M2 receives the second control signal S2. The first terminal of the capacitor C is coupled to the node P1, and the second terminal of the capacitor C is coupled to the control terminal of the driving transistor TD.

In the present embodiment, the driving transistor TD and the switches M1 to M6 may be implemented by transistors, respectively. In particular, the driving transistor TD and the switches M1 to M6 may be P-type transistors, respectively. In addition, the light-emitting diode OLED of the present embodiment may be, for example, an organic light-emitting diode or other types of electroluminescent elements. The number of light-emitting diodes may be one or a plurality, and the number thereof is not particularly limited.

It is worth mentioning that the switch M5 of the present embodiment may form one diode according to the diode connection. In particular, the cathode terminal of the diode (that is, the first terminal and control terminal of the switch M5) may receive the voltage control signal CS, and the anode terminal of the diode (that is, the second terminal of the switch M5) may be coupled to the first terminal of the light-emitting diode OLED.

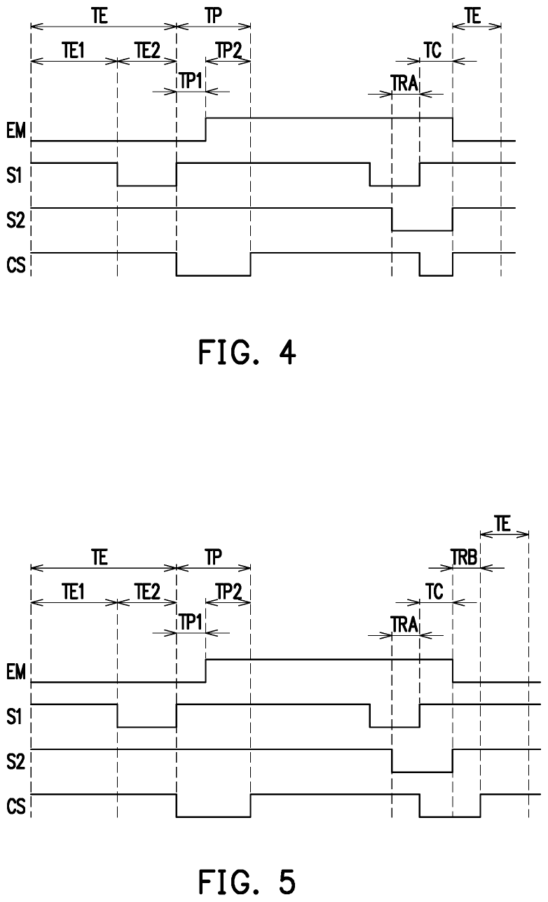

FIG. 4 is a diagram of a control waveform shown according to an embodiment corresponding to FIG. 3A to FIG. 3G. Referring to FIG. 4, the control waveform diagram may be divided into four phases such as a pre-reset phase TP, a first reset phase TRA, a compensation phase TC, and a light-emitting phase TE. In addition, the pre-reset phase TP, the first reset phase TRA, the compensation phase TC, and the light-emitting phase TE are not overlapped with each other. In particular, the first reset phase TRA is located (or occurs) after the pre-reset phase TP, the compensation phase TC is located (or occurs) after the first reset phase TRA, and the light-emitting phase TE is located (or occurs) after the compensation phase TC.

It should be noted that, for convenience of illustration, the switches that are turned off in FIG. 3A to FIG. 3G are indicated by crosses, and the switches that are turned on are indicated without crosses.

For details of the operation of the light-emitting diode apparatus 300 in an embodiment, please refer to FIG. 3A and FIG. 4 at the same time. In detail, when the light-emitting diode device 300 is operated in a first sub-phase TE1 of the light-emitting phase TE, the first control signal S1, the second control signal S2, and the voltage control signal CS may all be set to a disabled (for example, high voltage level) state, and the light-emitting control signal EM may be set to an enabled (for example, low voltage level) state, so that the switches M2, M3, M4, and M5 may be turned off, and the switches M1 and M6 may be turned on.

In this case, the second voltage generator 330 may couple the voltage provided by the reference voltage VREF to the control terminal of the driving transistor TD via the switch M1 and the capacitor C, so that the driving transistor TD may be turned on. Then, the driving transistor TD may provide the driving current ID to the light-emitting diode OLED according to the voltage provided by the reference voltage VREF, so as to drive the light-emitting diode OLED to perform a light-emitting action.

Please refer to FIG. 3B and FIG. 4 at the same time. When the light-emitting diode apparatus 300 is operated in a second sub-phase TE2 of the light-emitting phase TE, the second control signal S2 and the voltage control signal CS may both be kept in a disabled (for example, high voltage level) state, and the first control signal S1 and the light-emitting control signal EM may be set to an enabled (for example, low voltage level) state, so that the switches M2, M4, and M5 may be turned off, and the switches M1, M3, and M6 may be turned on.

In this case, similar to the operating action of FIG. 3A, the second voltage generator 330 may continuously couple the voltage provided by the reference voltage VREF to the control terminal of the driving transistor TD via the switch M1 and the capacitor C so that the driving transistor TD may continuously provide the driving current ID to the light-emitting diode OLED and light up the light-emitting diode OLED.

Next, referring to FIG. 3C and FIG. 4 at the same time, when the light-emitting diode device 300 is operated in a first sub-phase TP1 of the pre-reset phase TP, the first control signal S1 and the second control signal S2 may both be set to a disabled (for example, high voltage level) state, and the light-emitting control signal EM and the voltage control signal CS may both be set to an enabled (for example, low voltage level) state, so that the switches M2, M3, and M4 may be turned off, and the switches M1, M5, and M6 may be turned on.

It is worth mentioning that, when the voltage control signal CS is at a low voltage level, the voltage regulator 310 of the present embodiment may perform a pull down action on the voltage level of the second terminal of the driving transistor TD via a conduction path formed by the switch M5 and the switch M6 and according to the voltage control signal CS having a low voltage level, so that the voltage difference between the first terminal and the second terminal of the driving transistor TD is increased.

Please refer to FIG. 3D and FIG. 4 at the same time, when the light-emitting diode apparatus 300 is operated in a second sub-phase TP2 of the pre-reset phase TP, the light-emitting control signal EM, the first control signal S1, and the second control signal S2 may all be set to a disabled (for example, high voltage level) state, and the voltage control signal CS may be set to an enabled (for example, low voltage level) state, so that the switches M1, M3, M4, and M6 may be turned off and the switches M2 and M5 may be turned on.

When the switch M2 is in a conducting state, the second voltage generator 330 of the present embodiment may couple the voltage provided by the data voltage VDATA to the control terminal of the driving transistor TD via the switch M2 and the capacitor C. It is worth mentioning that since the voltage level of the data voltage VDATA of the present embodiment may be lower than the voltage level of the reference voltage VREF, when the light-emitting diode apparatus 300 drives the voltage level of the control terminal of the driving transistor TD via the voltage provided by the data voltage VDATA, in the present embodiment, the voltage difference between the control terminal and the first terminal of the driving transistor TD may be further expanded. Therefore, the voltage of the control terminal of the driving transistor TD may be closer to the voltage needed to open the channel of the driving transistor TD, or the channel of the driving transistor TD may be slightly opened in advance.

Next, please refer to FIG. 3E and FIG. 4 at the same time. When the light-emitting diode apparatus 300 is operated in the first reset phase TRA, the light-emitting control signal EM and the voltage control signal CS may both be set to a disabled (for example, high voltage standards) state, and the first control signal S1 and the second control signal S2 may both be set to an enabled (for example, low voltage level) state, so that the switches M1, M5, and M6 may be turned off, and the switches M2, M3, and M4 may be turned on.

In this case, the first voltage generator 320 may provide the reset voltage VINI to the control terminal of the driving transistor TD via a conduction path formed by the switch M3 and the switch M4, so as to perform a reset action on the control terminal of the driving transistor TD.

Please refer to FIG. 3F and FIG. 4 at the same time. When the light-emitting diode apparatus 300 is operated in the compensation phase TC, the light-emitting control signal EM and the first control signal S1 may both be set to a disabled (for example, high voltage level) state, and the second control signal S2 and the voltage control signal CS may be set to an enabled (for example, low voltage level) state, so that the switches M1, M3, M5, and M6 may be turned off, and the switches M2 and M4 may be turned on.

In this case, the voltage level of the control terminal of the driving transistor TD may be compensated to the compensation potential. In particular, the voltage value of the compensation potential may be the difference between the voltage value of the system high voltage OVDD and the voltage value of a threshold voltage of the driving transistor TD. In this way, the voltage level of the control terminal of the driving transistor TD may be corrected via the circuit operations of the pre-reset phase TP, the first reset phase TRA, and the compensation phase TC, thereby alleviating element characteristics errors generated by the driving transistor TD due to process differences, and the impact of conversion between different screen data.

Next, please refer to FIG. 3G and FIG. 4 at the same time. When the light-emitting diode apparatus 300 is operated in the light-emitting phase TE, the first control signal S1, the second control signal S2, and the voltage control signal CS may all be set to a disabled (for example, high voltage level) state, and the light-emitting control signal EM may be set to an enabled (for example, low voltage level) state, so that the switches M2, M3, M4, and M5 may be turned off, and the switches M1 and M6 may be turned on.

In this case, the first voltage generator 330 may couple the voltage provided by the reference voltage VREF to the control terminal of the driving transistor TD via the switch M1 and the capacitor C, so that the driving transistor TD may be turned on. In addition, since the voltage difference between the first terminal and the second terminal of the driving transistor TD is increased in the first sub-phase TP1 of the pre-reset phase TP, when the light-emitting diode apparatus 300 is operated in the light-emitting phase TE, the driving transistor TD may provide a relatively large driving current ID to the light-emitting diode OLED to drive the light-emitting diode OLED to perform a light-emitting action.

In other words, when the current magnitude of the driving current ID is increased, the light-emitting diode apparatus 300 of the present embodiment may effectively reduce the dynamic afterimage of the light-emitting diode apparatus 300 and improve the response time of the light-emitting diode apparatus 300 to improve display quality.

In particular, in the control waveform diagram shown in FIG. 4, the light-emitting diode apparatus 300 is sequentially operated in the pre-reset phase TP, the first reset phase TRA, the compensation phase TC, and the light-emitting phase TE. Under some design requirements (in some embodiments), the light-emitting diode apparatus 300 may perform the operating action of the first reset phase TRA before performing the operating action of the pre-reset phase TP. In other words, in some embodiments, the pre-reset phase TP may be located after the first reset phase TRA, the compensation phase TC may be located after the pre-reset phase TP, and the light-emitting phase TE may be located after the compensation phase TC.

In addition, under other design requirements (in other embodiments), the control waveform diagram may further include a second reset phase. Please refer to FIG. 5. FIG. 5 is a control waveform diagram shown according to another embodiment corresponding to FIG. 3A to FIG. 3G. In particular, a second reset phase TRB of the embodiment of FIG. 5 may be between the end time point of the compensation phase TC and the start time point of the light-emitting phase TE. That is, in other embodiments, the first reset phase TRA may be located after the pre-reset phase TP, the compensation phase TC may be located after the first reset phase TRA, the second reset phase TRB may be located after the compensation phase TC, and the light-emitting phase TE may be located after the second reset phase TRB.

Further, please refer to FIG. 3C and FIG. 5 at the same time. Unlike the embodiment of FIG. 4, in the embodiment shown in FIG. 5, the light-emitting diode apparatus 300 may continue to perform the operating action of the second reset phase TRB after finishing performing the operating action of the compensation phase TC. In particular, the operating action of the second reset phase TRB of the present embodiment may be the same as or similar to the operating action of the first sub-phase TP1 of the pre-reset phase TP (corresponding to the circuit action of FIG. 3C). Therefore, the circuit action of the light-emitting diode apparatus 300 in the second reset phase TRB may be deduced by analogy according to the related description of the circuit actions mentioned in FIG. 3C and FIG. 4 and is not repeated herein.

In other words, in the embodiment shown in FIG. 5, the voltage regulator 310 of the light-emitting diode apparatus 300 may further pull down the voltage level of the second terminal of the driving transistor TD in the second reset phase TRB, thereby increasing the current magnitude of the driving current ID again and further reducing the dynamic afterimage situation of the light-emitting diode apparatus 300.

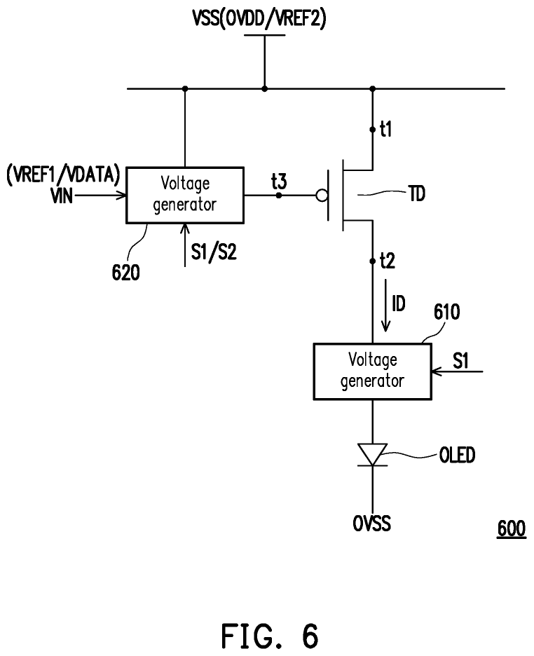

FIG. 6 is a diagram of the coupling of a light-emitting diode, a voltage regulator, a voltage generator, and a driving transistor shown according to another embodiment of the invention. Please refer to FIG. 6. In the present embodiment, a light-emitting diode apparatus 600 includes the driving transistor TD, a voltage regulator 610, a voltage generator 620, and the light-emitting diode OLED. The driving transistor TD has the first terminal t1 (for example, a source terminal), the second terminal t2 (for example, a drain terminal), and the control terminal t3 (for example, a gate terminal). The first terminal t1 of the driving transistor TD may receive a system voltage source VSS. In particular, the system voltage source VSS of the present embodiment may be switched to the system high voltage OVDD or a second reference voltage VREF2 according to the operating state of the light-emitting diode apparatus 600, wherein the voltage value of the system high voltage OVDD may be greater than the voltage value of the second reference voltage VREF2, but the invention is not limited thereto.

The voltage regulator 610 is coupled to the second terminal t2 of the driving transistor TD. The first terminal (for example, an anode terminal) of the light-emitting diode OLED is coupled to the voltage regulator 610, and the second terminal (for example, a cathode terminal) of the light-emitting diode OLED receives the system low voltage OVSS. The voltage generator 620 is coupled to the control terminal t3 and the first terminal t1 of the driving transistor TD. The voltage generator 620 may receive the first control signal S1 (or the second control signal S2) and an input voltage VIN. In particular, according to the operating state of the light-emitting diode apparatus 600, the input voltage VIN of the present embodiment may be switched to a first reference voltage VREF1 or the data voltage VDATA, wherein the voltage value of the data voltage VDATA may be greater than the voltage value of the first reference voltage VREF1, but the invention is not limited thereto.

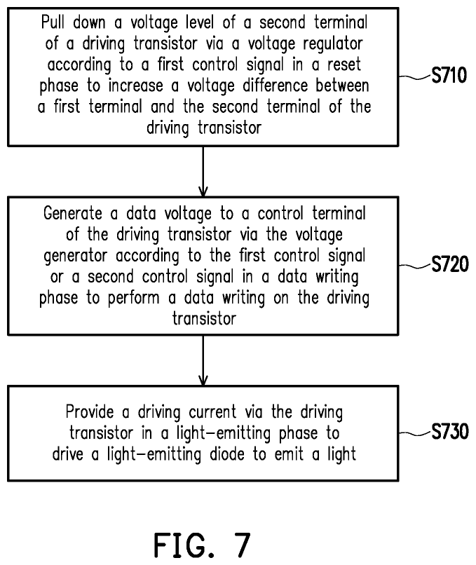

FIG. 7 is a flowchart of a control method of a light-emitting diode apparatus shown according to another embodiment of the invention. Please refer to FIG. 6 and FIG. 7 at the same time. In step S710, when the light-emitting diode apparatus 600 is operated in a reset phase, the voltage regulator 610 may pull down the voltage level of the second terminal t2 of the driving transistor TD according to the first control signal S1, so that the voltage difference between the first terminal t1 and the second terminal t2 of the driving transistor TD may be increased.

For example, in the reset phase, the first control signal S1 of the present embodiment may be set to an enabled (for example, low voltage level) state. In this case, the voltage regulator 610 may pull down the voltage level of the second terminal t2 of the driving transistor TD according to the first control signal S1 having a low voltage level, so that the voltage difference between the first terminal t1 and the second terminals t2 of the driving transistor TD may be increased.

In step S720, when the light-emitting diode apparatus 600 is operated in a data writing phase, the input voltage VIN may be the data voltage VDATA. In this case, the voltage generator 620 may generate the data voltage VDATA to the control terminal t3 of the driving transistor TD according to the first control signal S1 or the second control signal S2 to perform the operating action of data writing on the driving transistor TD. In step S730, when the light-emitting diode apparatus 600 is operated in a light-emitting phase, the driving transistor TD may provide the driving current ID to the light-emitting diode OLED to emit a light.

It is worth mentioning that since the voltage regulator 610 of the present embodiment pulls down the voltage level of the second terminal t2 of the driving transistor TD in advance in the reset phase to increase the voltage difference between the first terminal t1 and the second terminal t2 of the driving transistor TD, when the voltage difference between the first terminal t1 and the second terminal t2 of the driving transistor TD is increased, when the light-emitting diode apparatus 100 is operated in the light-emitting phase, the driving transistor TD may provide a relatively large driving current ID to light up the light-emitting diode OLED. Therefore, in the present embodiment, by increasing the current magnitude of the driving current ID, the situation of dynamic afterimage of the light-emitting diode apparatus 600 is reduced, and the response time of the light-emitting diode apparatus 600 is improved, thereby improving the overall display quality.

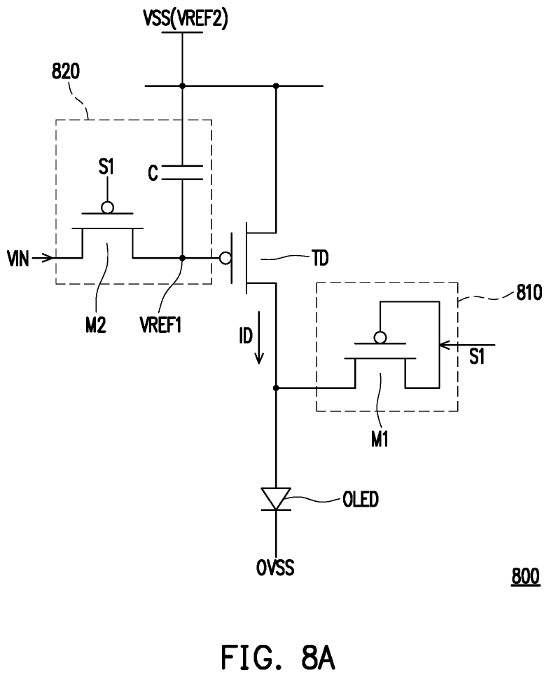

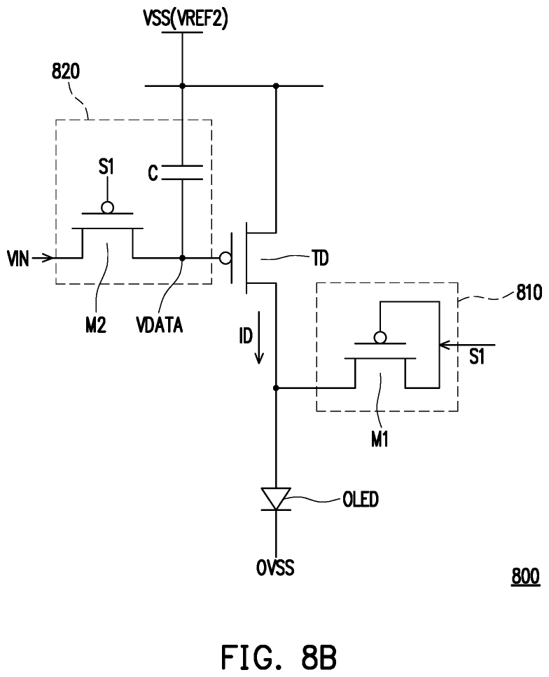

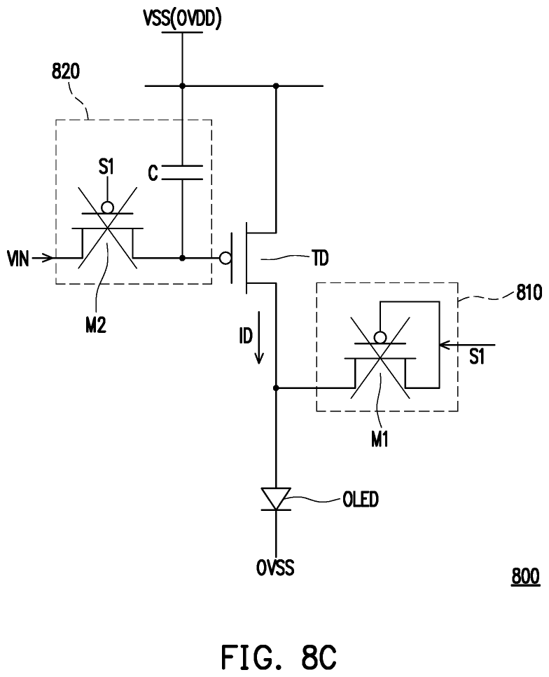

FIG. 8A to FIG. 8C are control diagrams of a light-emitting diode apparatus shown according to the first embodiment shown in FIG. 6 of the invention. In the present embodiment, a light-emitting diode apparatus 800 includes the driving transistor TD, a voltage regulator 810, a voltage generator 820, and the light-emitting diode OLED.

The voltage regulator 810 includes the switch M1. The first terminal and the control terminal of the switch M1 are coupled to each other and receive the first control signal S1 together. The second terminal of the switch M1 is coupled to the first terminal of the light-emitting diode OLED. The voltage generator 820 includes the switch M2 and the capacitor C. The first terminal of the switch M2 receives the input voltage VIN, the second terminal of the switch M2 is coupled to the control terminal of the driving transistor TD, and the control terminal of the switch M2 receives the first control signal S1. The first terminal of the capacitor C is coupled to the first terminal of the driving transistor TD, and the second terminal of the capacitor C is coupled to the control terminal of the driving transistor TD.

It is worth mentioning that the switch M1 of the present embodiment may form one diode according to the diode connection. In particular, the cathode terminal of the diode (that is, the first terminal and the control terminal of the switch M1) may receive the first control signal S1, and the anode terminal of the diode (that is, the second terminal of the switch M1) may be coupled to the first terminal of the light-emitting diode OLED.

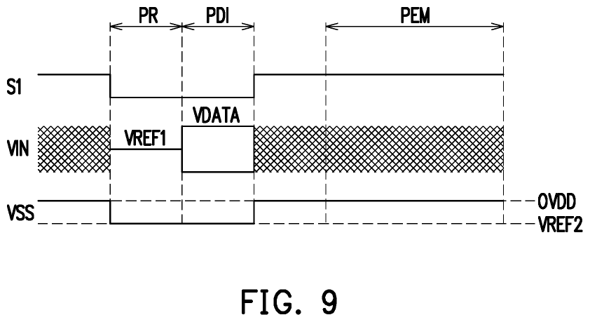

FIG. 9 is a diagram of a control waveform shown according to an embodiment corresponding to FIG. 8A to FIG. 8C. Referring to FIG. 9, the control waveform diagram may be divided into three phases such as a reset phase PR, a data writing phase PDI, and a light-emitting phase PEM. In addition, the reset phase PR, the data writing phase PDI, and the light-emitting phase PEM are not overlapped with each other. In particular, the data writing phase PDI is located (or occurs) after the reset phase PR, and the light-emitting phase PEM is located (or occurs) after the data writing phase PDI.

It should be noted that, for convenience of illustration, the switches that are turned off in FIG. 8A to FIG. 8C are indicated by crosses, and the switches that are turned on are indicated without crosses.

For details of the operation of the light-emitting diode apparatus 800, please refer to FIG. 8A and FIG. 9 at the same time. In detail, when the light-emitting diode apparatus 800 is operated in the reset phase PR, the first control signal S1 may be set to an enabled (for example, low voltage level) state, so that the switches M1 and M2 may be turned on. Moreover, in the reset phase PR, the input voltage VIN of the present embodiment may be the first reference voltage VREF1, and the system voltage source VSS may be the second reference voltage VREF2. In particular, the voltage value of the first reference voltage VREF1 may be greater than the voltage value of the second reference voltage VREF2.

Further, when the first control signal S1 is at a low voltage level, the voltage regulator 810 of the present embodiment may pull down the voltage level of the second terminal of the driving transistor TD via a conduction path formed by the switch M1 and according to the first control signal S1 having a low voltage level, so that the voltage difference between the first terminal and the second terminal of the driving transistor TD is increased.

At the same time, the voltage generator 820 may also provide the first reference voltage VREF1 to the control terminal of the driving transistor TD via the conduction path formed by the switch M2. It is worth mentioning that in the reset phase PR, the voltage difference between the control terminal and the first terminal of the driving transistor TD (that is, the voltage difference between the first reference voltage VREF1 and the second reference voltage VREF2) may be greater than the voltage value of the critical voltage of the driving transistor TD.

In other words, when the voltage difference between the first terminal (that is, the source terminal) and the second terminal (that is, the drain terminal) of the driving transistor TD is increased, and the voltage difference between the control terminal (that is, the gate terminal) and the first terminal of the driving transistor TD is greater than the voltage value of the threshold voltage of the driving transistor TD, the current magnitude of the driving current ID may be relatively increased.

Please refer to FIG. 8B and FIG. 9 at the same time. When the light-emitting diode apparatus 800 is operated in the data writing phase PDI, the first control signal S1 may be maintained in an enabled (for example, low voltage level) state, so that the switches M1 and M2 are continuously turned on. Moreover, in the data writing phase PDI, the input voltage VIN of the present embodiment may be the data voltage VDATA, and the system voltage source VSS may be maintained at the second reference voltage VREF2.

In this case, the voltage generator 820 may provide the data voltage VDATA to the control terminal of the driving transistor TD via a conduction path formed by the switch M2 to perform the operating action of data writing on the driving transistor TD.

Please refer to FIG. 8C and FIG. 9 at the same time, when the light-emitting diode apparatus 800 is operated in the light-emitting phase PEM, the first control signal S1 may be set to a disabled (for example, high voltage level) state so that the switches M1 and M2 may be turned off. Moreover, in the light-emitting phase PEM, the system voltage source VSS of the present embodiment may be the system high voltage OVDD.

In this case, the voltage generator 820 may couple the voltage provided by the system high voltage OVDD to the control terminal of the driving transistor TD via the capacitor C, so that the driving transistor TD may be turned on. In addition, since the voltage difference between the first terminal and the second terminal of the driving transistor TD is increased in the reset phase PR, when the light-emitting diode apparatus 800 is operated in the light-emitting phase PEM, the driving transistor TD may provide a relatively large driving current ID to the light-emitting diode OLED to drive the light-emitting diode OLED to perform a light-emitting action.

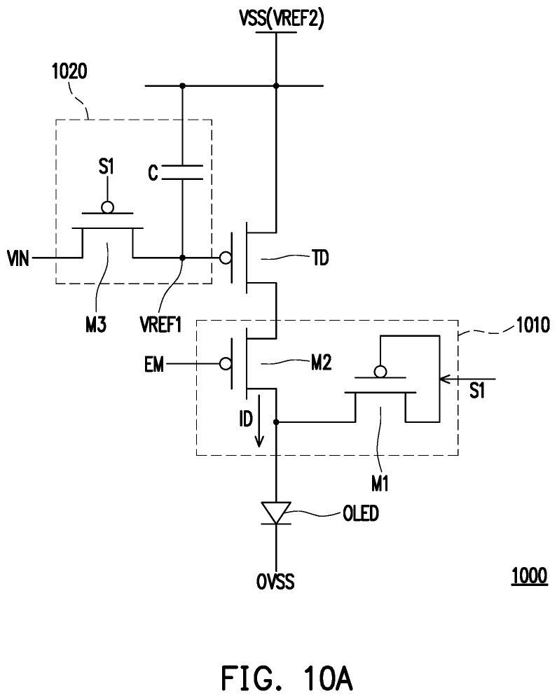

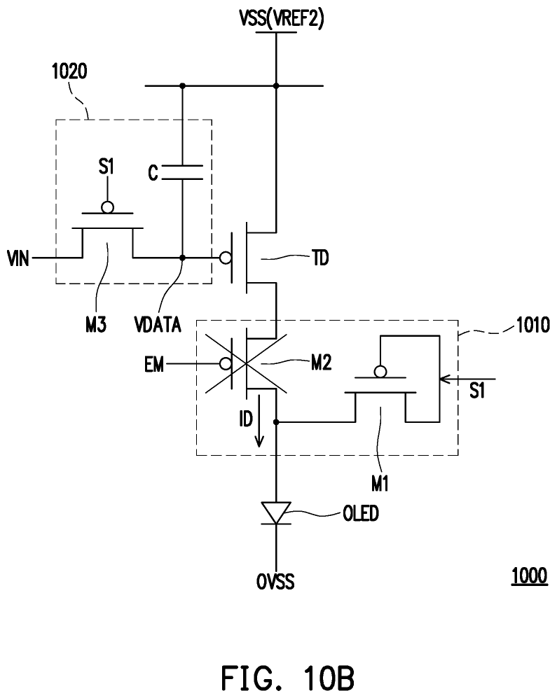

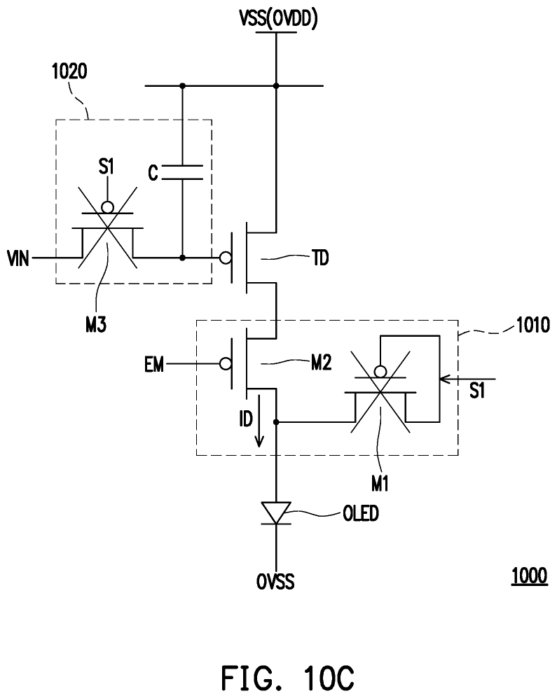

FIG. 10A to FIG. 10C are control diagrams of a light-emitting diode apparatus shown according to the second embodiment shown in FIG. 6 of the invention. In the present embodiment, a light-emitting diode apparatus 1000 includes the driving transistor TD, a voltage regulator 1010, a voltage generator 1020, and the light-emitting diode OLED.

The voltage regulator 1010 includes the switch M1 and the switch M2. The first terminal and the control terminal of the switch M1 are coupled to each other and receive the first control signal S1 together. The second terminal of the switch M1 is coupled to the first terminal of the light-emitting diode OLED. The first terminal of the switch M2 is coupled to the second terminal of the driving transistor TD, the second terminal of the switch M2 is coupled to the first terminal of the light-emitting diode OLED, and the control terminal of the switch M2 receives the light-emitting control signal EM.

The voltage generator 1020 includes the switch M3 and the capacitor C. The first terminal of the switch M3 receives the input voltage VIN, the second terminal of the switch M3 is coupled to the control terminal of the driving transistor TD, and the control terminal of the switch M3 receives the first control signal S1. The first terminal of the capacitor C is coupled to the first terminal of the driving transistor TD, and the second terminal of the capacitor C is coupled to the control terminal of the driving transistor TD.

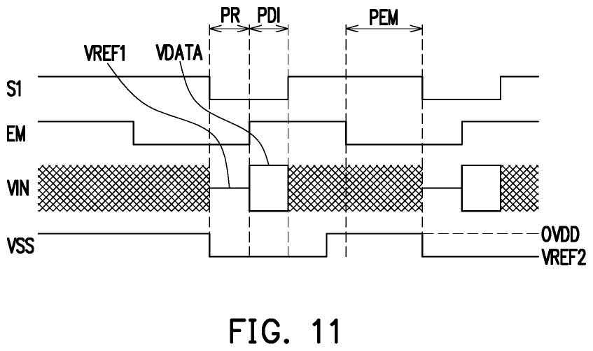

FIG. 11 is a diagram of a control waveform shown according to an embodiment corresponding to FIG. 10A to FIG. 10C. Referring to FIG. 11, the control waveform diagram may be divided into three phases such as the reset phase PR, the data writing phase PDI, and the light-emitting phase PEM. In addition, the reset phase PR, the data writing phase PDI, and the light-emitting phase PEM are not overlapped with each other. In particular, the data writing phase PDI is located (or occurs) after the reset phase PR, and the light-emitting phase PEM is located (or occurs) after the data writing phase PDI.

It should be noted that, for convenience of illustration, the switches that are turned off in FIG. 10A to FIG. 10C are indicated by crosses, and the switches that are turned on are indicated without crosses.

For details of the operation of the light-emitting diode apparatus 1000, please refer to FIG. 10A and FIG. 11 at the same time. In detail, when the light-emitting diode apparatus 1000 is operated in the reset phase PR, the first control signal S1 and the light-emitting control signal EM may be set to an enabled (for example, low voltage level) state, so that the switches M1, M2, and M3 may be turned on. Moreover, in the reset phase PR, the input voltage VIN of the present embodiment may be the first reference voltage VREF1, and the system voltage source VSS may be the second reference voltage VREF2. In particular, the voltage value of the first reference voltage VREF1 may be greater than the voltage value of the second reference voltage VREF2.

Specifically, when the first control signal S1 and the light-emitting control signal EM are both at a low voltage level, the voltage regulator 1010 of the present embodiment may pull down the voltage level of the second terminal of the driving transistor TD via a conduction path formed by the switches M1 and M2 and according to the first control signal S1 having a low voltage level, so that the voltage difference between the first terminal and the second terminal of the driving transistor TD is increased.

At the same time, the voltage generator 1020 may also provide the first reference voltage VREF1 to the control terminal of the driving transistor TD via the conduction path formed by the switch M3. It is worth mentioning that in the reset phase PR, the voltage difference between the control terminal and the first terminal of the driving transistor TD (that is, the voltage difference between the first reference voltage VREF1 and the second reference voltage VREF2) may be greater than the voltage value of the critical voltage of the driving transistor TD.

In other words, when the voltage difference between the first terminal (that is, the source terminal) and the second terminal (that is, the drain terminal) of the driving transistor TD is increased, and the voltage difference between the control terminal (that is, the gate terminal) and the first terminal of the driving transistor TD is greater than the voltage value of the threshold voltage of the driving transistor TD, the current magnitude of the driving current ID may be relatively increased.

Please refer to FIG. 10B and FIG. 11 at the same time. When the light-emitting diode apparatus 1000 is operated in the data writing phase PDI, the first control signal S1 may be maintained in an enabled (for example, low voltage level) state, and the light-emitting control signal EM It may be set to a disabled (for example, high voltage level) state, so that the switch M2 may be turned off and the switches M1 and M3 may be turned on. Moreover, in the data writing phase PDI, the input voltage VIN of the present embodiment may be the data voltage VDATA, and the system voltage source VSS may be maintained at the second reference voltage VREF2.

In this case, the voltage generator 1020 may provide the data voltage VDATA to the control terminal of the driving transistor TD via a conduction path formed by the switch M3 to perform the operating action of data writing on the driving transistor TD.

Please refer to both FIG. 10C and FIG. 11. When the light-emitting diode apparatus 1000 is operated in the light-emitting phase PEM, the first control signal S1 may be set to a disabled (for example, high voltage level) state, and the light-emitting control signal EM may be set to an enabled (for example, low voltage level) state, so that the switch M2 may be turned on and the switches M1 and M3 may be turned off. Moreover, in the light-emitting phase PEM, the system voltage source VSS of the present embodiment may be the system high voltage OVDD.

In this case, the voltage generator 1020 may couple the voltage provided by the system high voltage OVDD to the control terminal of the driving transistor TD via the capacitor C, so that the driving transistor TD may be turned on. In addition, since the voltage difference between the first terminal and the second terminal of the driving transistor TD is increased in the reset phase PR, when the light-emitting diode apparatus 1000 is operated in the light-emitting phase PEM, the driving transistor TD may provide a relatively large driving current ID to the light-emitting diode OLED to drive the light-emitting diode OLED to perform a light-emitting action.

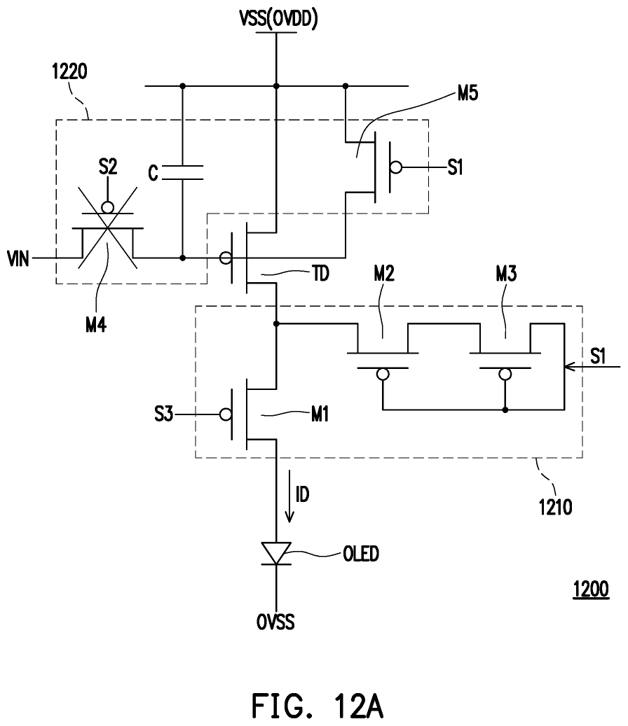

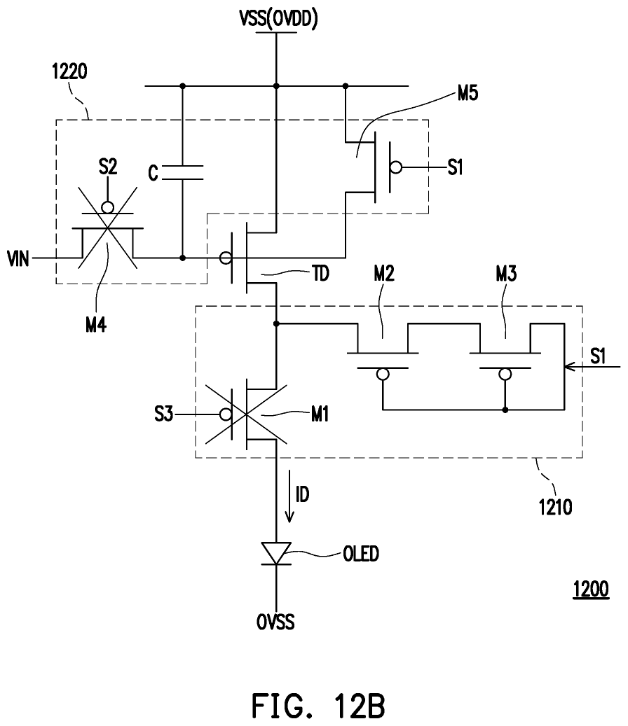

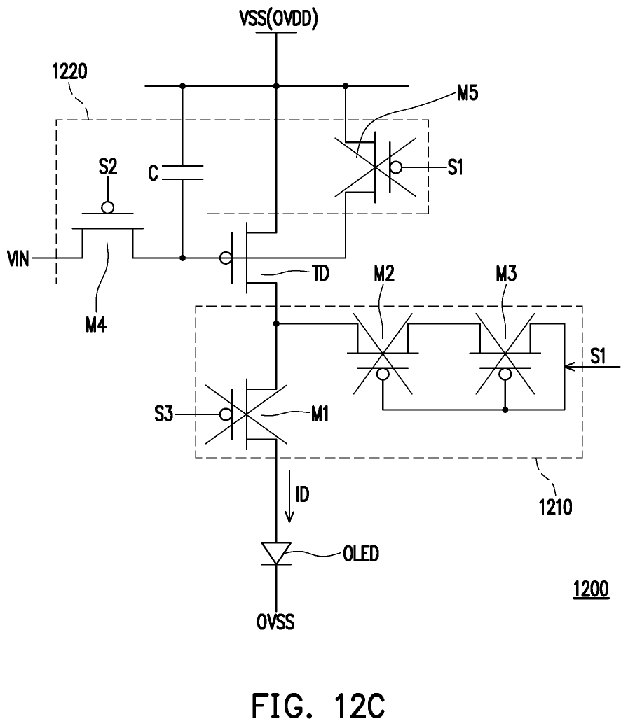

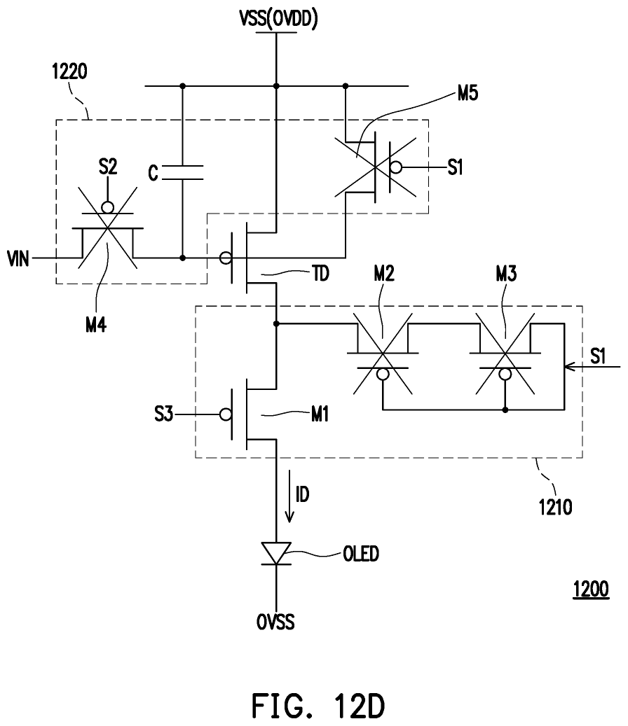

FIG. 12A to FIG. 12D are control diagrams of a light-emitting diode apparatus shown according to the third embodiment shown in FIG. 6 of the invention. In the present embodiment, a light-emitting diode apparatus 1200 includes the driving transistor TD, a voltage regulator 1210, a voltage generator 1220, and the light-emitting diode OLED.

The voltage regulator 1210 includes the switches M1, M2, and M3. The first terminal of the switch M1 is coupled to the second terminal of the driving transistor TD, the second terminal of the switch M1 is coupled to the first terminal of the light-emitting diode OLED, and the control terminal of the switch M1 receives a third control signal S3. The first terminal of the switch M2 is coupled to the second terminal of the driving transistor TD. The first terminal of the switch M3 is coupled to the second terminal of the switch M2, the second terminal and the control terminal of the switch M3 and the control terminal of the switch M2 are coupled to each other, and the first terminal, the second terminal, and the control terminal of the switch M3 receive the first control signal S1 together.

The voltage generator 1220 includes the switch M4, the switch M5, and the capacitor C. The first terminal of the switch M4 receives the input voltage VIN, the second terminal of the switch M4 is coupled to the control terminal of the driving transistor TD, and the control terminal of the switch M4 receives the second control signal S2. The first terminal of the switch M5 receives the system voltage source VSS, the second terminal of the switch M5 is coupled to the control terminal of the driving transistor TD, and the control terminal of the switch M5 receives the first control signal S1.

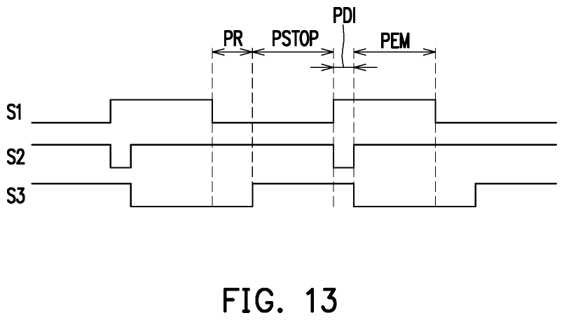

FIG. 13 is a diagram of a control waveform shown according to an embodiment corresponding to FIG. 12A to FIG. 12D. Referring to FIG. 13, the control waveform diagram may be divided into four phases such as the reset phase PR, a light stop phase PSTOP, the data writing phase PDI, and the light-emitting phase PEM. In addition, the reset phase PR, the light stop phase PSTOP, the data writing phase PDI, and the light-emitting phase PEM are not overlapped with each other. In particular, the light stop phase PSTOP is located (or occurs) after the reset phase PR, the data writing phase PDI is located (or occurs) after the light stop phase PSTOP, and the light-emitting phase PEM is located (or occurs) after the data writing phase PDI.

It should be noted that, for convenience of illustration, the switches that are turned off in FIG. 12A to FIG. 12D are indicated by crosses, and the switches that are turned on are indicated without crosses.

For details of the operation of the light-emitting diode apparatus 1200, please refer to FIG. 12A and FIG. 13 at the same time. In detail, when the light-emitting diode apparatus 1200 is operated in the reset phase PR, the first control signal S1 and the third control signal S3 may be set to an enabled (for example, low voltage level) state, and the second control signal S2 may be set to a disabled (for example, high voltage level) state, so that the switches M1, M2, M3, and M5 may be turned on, and the switch M4 may be turned off. Moreover, in the reset phase PR, the system voltage source VSS of the present embodiment may be the system high voltage OVDD.

Specifically, when the first control signal S1 is at a low voltage level, the voltage regulator 1210 of the present embodiment may pull down the voltage level of the second terminal of the driving transistor TD via a conduction path formed by the switches M2 and M3 and according to the first control signal S1 having a low voltage level, so that the voltage difference between the first terminal and the second terminal of the driving transistor TD is increased.

In other words, when the voltage difference between the first terminal (for example, a source terminal) and the second terminal (for example, a drain terminal) of the driving transistor TD is increased, the current magnitude of the driving current ID may be relatively increased.

Please refer to FIG. 12B and FIG. 13. When the light-emitting diode apparatus 1200 is operated in the light stop phase PSTOP, the first control signal S1 may be set to an enabled (for example, low voltage level) state, and the second control signal S2 and the third control signal S2 may be set to a disabled (for example, high voltage level) state, so that the switches M2, M3, and M5 may be turned on, and the switches M1 and M4 may be turned off.

In this case, the voltage regulator 1210 may not be able to turn on the conduction path between the driving transistor TD and the light-emitting diode OLED according to the third control signal S3 having a high voltage level, so that the driving transistor TD stops emitting light to the light-emitting diode OLED in the light stop phase PSTOP.

Please refer to FIG. 12C and FIG. 13 at the same time. When the light-emitting diode apparatus 1200 is operated in the data writing phase PDI, the second control signal S2 may be set to an enabled (for example, low voltage level) state, and the first control signal S1 and the third control signal S3 may be set to a disabled (for example, high voltage level) state, so that the switch M4 may be turned on, and the switches M1, M2, M3, and M4 may be turned off. Moreover, in the data writing phase PDI, the input voltage VIN of the present embodiment may be the data voltage VDATA.

In this case, the voltage generator 1220 may provide the data voltage VDATA to the control terminal of the driving transistor TD via a conduction path formed by the switch M4 to perform the operating action of data writing on the driving transistor TD.

Please refer to FIG. 12D and FIG. 13 at the same time, when the light-emitting diode apparatus 1200 is operated in the light-emitting phase PEM, the third control signal S3 may be set to an enabled (for example, low voltage level) state, and the first control signal S1 and the second control signal S2 may be set to a disabled (for example, high voltage level) state, so that the switches M2 to M5 may be turned off and the switch M1 may be turned on.

In this case, the voltage generator 1220 may couple the voltage provided by the system high voltage OVDD to the control terminal of the driving transistor TD via the capacitor C, so that the driving transistor TD may be turned on. In addition, since the voltage difference between the first terminal and the second terminal of the driving transistor TD is increased in the reset phase PR, when the light-emitting diode apparatus 1200 is operated in the light-emitting phase PEM, the driving transistor TD may provide a relatively large driving current ID to the light-emitting diode OLED to drive the light-emitting diode OLED to perform a light-emitting action.

It should be noted that in embodiments such as FIG. 8A to FIG. 8C, FIG. 10A to FIG. 10C, and FIG. 12A to FIG. 12D, the switches M1 to M5 and the driving transistor TD may be P-type transistors, respectively. In addition, the light-emitting diode OLED may be, for example, an organic light-emitting diode or other types of electroluminescent elements. The number of light-emitting diodes may be one or a plurality, and the number thereof is not particularly limited.

According to the descriptions of embodiments such as FIG. 8A to FIG. 8C, FIG. 10A to FIG. 10C, and FIG. 12A to FIG. 12D, it may be known that when the current magnitude of the driving current ID is increased, the light-emitting diode apparatuses 800, 1000, and 1200 may effectively reduce the occurrence of dynamic afterimages, and the response time of the light-emitting diode apparatuses is improved, thereby improving display quality.

Based on the above, in the light-emitting diode apparatus of the invention, an operating action of a pre-reset phase may be added before the first reset phase is performed. In the pre-reset phase, the light-emitting diode apparatus may pull down the voltage level of the second terminal (i.e., the drain terminal) of the driving transistor in advance via the voltage regulator, thereby increasing the voltage difference between the first terminal (i.e., the source terminal) and the second terminal of the driving transistor. When the light-emitting diode apparatus is operated in the light-emitting phase, the current magnitude of the driving current may be effectively increased, thereby alleviating the dynamic afterimage situation of the light-emitting diode apparatus and improving the response time of the light-emitting diode apparatus so as to improve the overall display quality.

What is claimed is:

1. A control method of a light-emitting diode apparatus, comprising:
pulling down a voltage level of a second terminal of a driving transistor via a voltage regulator according to a light-emitting control signal and a voltage control signal in a pre-reset phase to increase a voltage difference between a first terminal and the second terminal of the driving transistor;
receiving a reset voltage via a control terminal of the driving transistor in a first reset phase to reset the control terminal of the driving transistor;
compensating the control terminal of the driving transistor to a compensation potential in a compensation phase; and
providing a driving current via the driving transistor in a light-emitting phase to drive a light-emitting diode to emit a light.

2. The control method of claim 1, wherein the first reset phase is located after the pre-reset phase, the compensation phase is located after the first reset phase, and the light-emitting phase is located after the compensation phase.

3. The control method of claim 1, wherein the pre-reset phase is located after the first reset phase, the compensation phase is located after the pre-reset phase, and the light-emitting phase is located after the compensation phase.

4. The control method of claim 1, wherein the voltage control signal is operated at a low voltage level in the pre-reset phase.

5. The control method of claim 1, wherein the step of receiving the reset voltage via the control terminal of the driving transistor in the first reset phase to reset the control terminal of the driving transistor comprises:
providing the reset voltage to the control terminal of the driving transistor via a first voltage generator according to a first control signal and a second control signal in the first reset phase; and
generating a reference voltage or a data voltage via a second voltage generator according to the second control signal and the light-emitting control signal.

6. The control method of claim 1, wherein a voltage value of the compensation potential is a voltage difference between a voltage value of a system high voltage and a voltage value of a threshold voltage of the driving transistor.

7. The control method of claim 1, wherein the control method further comprises:
pulling down the voltage level of the second terminal of the driving transistor again via the voltage regulator according to the light-emitting control signal and the voltage control signal in a second reset phase to increase the voltage difference between the first terminal and the second terminal of the driving transistor again.

8. The control method of claim 7, wherein the first reset phase is located after the pre-reset phase, the compensation phase is located after the first reset phase, the second reset phase is located after the compensation phase, and the light-emitting phase is located after the second reset phase.

9. The control method of claim 1, wherein the light-emitting diode comprises an organic light-emitting diode.

10. A light-emitting diode apparatus, comprising:
a driving transistor, wherein a first terminal thereof receives a system high voltage;
a voltage regulator coupled to a second terminal of the driving transistor; and
a light-emitting diode, wherein a first terminal thereof is coupled to the voltage regulator and a second terminal thereof receives a system low voltage, wherein,
the voltage regulator pulls down a voltage level of the second terminal of the driving transistor according to a light-emitting control signal and a voltage control signal in a pre-reset phase to increase a voltage difference between a first terminal and the second terminal of the driving transistor,
a control terminal of the driving transistor receives a reset voltage in a first reset phase to reset the control terminal of the driving transistor,
the control terminal of the driving transistor is compensated to a compensation potential in a compensation phase,
a driving current is provided via the driving transistor in a light-emitting phase to drive the light-emitting diode to emit a light.

11. The light-emitting diode apparatus of claim 10, wherein the first reset phase is located after the pre-reset phase, the compensation phase is located after the first reset phase, and the light-emitting phase is located after the compensation phase.

12. The light-emitting diode apparatus of claim 10, wherein the pre-reset phase is located after the first reset phase, the compensation phase is located after the pre-reset phase, and the light-emitting phase is located after the compensation phase.

13. The light-emitting diode apparatus of claim 10, wherein the voltage control signal is operated at a low voltage level in the pre-reset phase.

14. The light-emitting diode apparatus of claim 10, wherein the light-emitting diode apparatus further comprises:
a first voltage generator coupled between the control terminal of the driving transistor and the voltage regulator, wherein the first voltage generator provides the reset voltage to the control terminal of the driving transistor according to a first control signal and a second control signal in the first reset phase; and
a second voltage generator coupled to the control terminal of the driving transistor and generating a reference voltage or a data voltage according to the second control signal and the light-emitting control signal.

15. The light-emitting diode apparatus of claim 10, wherein a voltage value of the compensation potential is a voltage difference between a voltage value of the system high voltage and a voltage value of a threshold voltage of the driving transistor.

16. The light-emitting diode apparatus of claim 10, wherein the voltage regulator comprises:
a first switch, wherein a first terminal and a control terminal thereof receive the voltage control signal together, and a second terminal thereof is coupled to the first terminal of the light-emitting diode; and
a second switch, wherein a first terminal thereof is coupled to the first terminal of the light-emitting diode, a second terminal thereof is coupled to the second terminal of the driving transistor, and a control terminal thereof receives the light-emitting control signal.

17. The light-emitting diode apparatus of claim 14, wherein the first voltage generator comprises:
a first switch, wherein a first terminal thereof receives the reset voltage, and a control terminal thereof receives the first control signal; and
a second switch, wherein a first terminal thereof is coupled to a second terminal of the first switch and the voltage regulator, a second terminal thereof is coupled to the control terminal of the driving transistor, and a control terminal thereof receives the second control signal.

18. The light-emitting diode apparatus of claim 14, wherein the second voltage generator comprises:
a first switch, wherein a first terminal thereof receives the reference voltage, a second terminal thereof is coupled to a first node, and a control terminal thereof receives the light-emitting control signal;
a second switch, wherein a first terminal thereof receives the data voltage, a second terminal thereof is coupled to the first node, and a control terminal thereof receives the second control signal; and
a capacitor, wherein a first terminal thereof is coupled to the first node and a second terminal thereof is coupled to the control terminal of the driving transistor.

19. The light-emitting diode apparatus of claim 10, wherein the voltage regulator pulls down the voltage level of the second terminal of the driving transistor again according to the light-emitting control signal and the voltage control signal in a second reset phase to increase the voltage difference between the first terminal and the second terminal of the driving transistor again.

20. The light-emitting diode apparatus of claim 19, wherein the first reset phase is located after the pre-reset phase, the compensation phase is located after the first reset phase, the second reset phase is located after the compensation phase, and the light-emitting phase is located after the second reset phase.

21. The light-emitting diode apparatus of claim 10, wherein the light-emitting diode comprises an organic light-emitting diode.

22. A control method of a light-emitting diode apparatus, comprising:
pulling down a voltage level of a second terminal of a driving transistor via a voltage regulator according to a first control signal in a reset phase to increase a voltage difference between a first terminal and the second terminal of the driving transistor;
generating a data voltage to a control terminal of the driving transistor via the voltage generator according to the first control signal or a second control signal in a data writing phase to perform a data writing on the driving transistor; and
providing a driving current via the driving transistor in a light-emitting phase to drive a light-emitting diode to emit a light.

23. The control method of claim 22, wherein the first control signal is operated at a low voltage level in the reset phase.

24. The control method of claim 22, wherein the data writing phase is located after the reset phase, and the light-emitting phase is located after the data writing phase.

25. The control method of claim 22, wherein the voltage generator generates a first reference voltage to the control terminal of the driving transistor according to the first control signal in the reset phase, and a voltage difference between the control terminal and the first terminal of the driving transistor is greater than a voltage value of a threshold voltage of the driving transistor.

26. The control method of claim 22, wherein the control method further comprises:
stopping the driving transistor from emitting a light to the light-emitting diode via the voltage regulator according to a third control signal in a light stop phase.

27. The control method of claim 26, wherein the light stop phase is located after the reset phase, the data writing phase is located after the light stop phase, and the light-emitting phase is located after the data writing phase.

28. The control method of claim 22, wherein the light-emitting diode comprises an organic light-emitting diode.

29. A light-emitting diode apparatus, comprising:
a driving transistor, wherein a first terminal thereof receives a system voltage source;
a voltage regulator coupled to a second terminal of the driving transistor;
a light-emitting diode, wherein a first terminal thereof is coupled to the voltage regulator and a second terminal thereof receives a system low voltage; and
a voltage generator coupled to a control terminal and the first terminal of the driving transistor, wherein,
the voltage regulator pulls down a voltage level of the second terminal of the driving transistor according to a first control signal in a reset phase to increase a voltage difference between the first terminal and the second terminal of the driving transistor,
the voltage generator generates a data voltage to the control terminal of the driving transistor according to the first control signal or a second control signal in a data writing phase to perform a data writing on the driving transistor,
the driving transistor provides a driving current in a light-emitting phase to drive the light-emitting diode to emit a light.

30. The light-emitting diode apparatus of claim 29, wherein the first control signal is operated at a low voltage level in the reset phase.

31. The light-emitting diode apparatus of claim 29, wherein the data writing phase is located after the reset phase, and the light-emitting phase is located after the data writing phase.

32. The light-emitting diode apparatus of claim 29, wherein the system voltage source is a system high voltage or a second reference voltage.

33. The light-emitting diode apparatus of claim 29, wherein the voltage generator generates a first reference voltage to the control terminal of the driving transistor according to the first control signal in the reset phase, and a voltage difference between the control terminal and the first terminal of the driving transistor is greater than a voltage value of a threshold voltage of the driving transistor.

34. The light-emitting diode apparatus of claim 29, wherein the voltage regulator comprises:
a first switch, wherein a first terminal and a control terminal thereof receive the first control signal together, and a second terminal thereof is coupled to the first terminal of the light-emitting diode,
wherein the voltage generator comprises:
a second switch, wherein a first terminal thereof receives an input voltage, a second terminal thereof is coupled to the control terminal of the driving transistor, and a control terminal thereof receives the first control signal; and
a capacitor, wherein a first terminal thereof is coupled to the first terminal of the driving transistor and a second terminal thereof is coupled to the control terminal of the driving transistor.

35. The light-emitting diode apparatus of claim 29, wherein the voltage regulator comprises:
a first switch, wherein a first terminal and a control terminal thereof receive the first control signal together, and a second terminal thereof is coupled to the first terminal of the light-emitting diode; and
a second switch, wherein a first terminal thereof is coupled to the second terminal of the driving transistor, a second terminal thereof is coupled to the first terminal of the light-emitting diode, and a control terminal thereof receives a light-emitting control signal,
wherein the voltage generator comprises:
a third switch, wherein a first terminal thereof receives an input voltage, a second terminal thereof is coupled to the control terminal of the driving transistor, and a control terminal thereof receives the first control signal; and
a capacitor, wherein a first terminal thereof is coupled to the first terminal of the driving transistor and a second terminal thereof is coupled to the control terminal of the driving transistor.

36. The light-emitting diode apparatus of claim 29, wherein the voltage regulator comprises:
a first switch, wherein a first terminal thereof is coupled to the second terminal of the driving transistor, a second terminal thereof is coupled to the first terminal of the light-emitting diode, and a control terminal thereof receives a third control signal;
a second switch, wherein a first terminal thereof is coupled to the second terminal of the driving transistor;
a third switch, wherein a first terminal thereof is coupled to a second terminal of the second switch, and a second terminal and a control terminal thereof receive the first control signal together with a control terminal of the second switch,
wherein the voltage generator comprises:
a fourth switch, wherein a first terminal thereof receives an input voltage, a second terminal thereof is coupled to the control terminal of the driving transistor, and a control terminal thereof receives the second control signal;
a fifth switch, wherein a first terminal thereof receives the system voltage source, a second terminal thereof is coupled to the control terminal of the driving transistor, and a control terminal thereof receives the first control signal; and
a capacitor, wherein a first terminal thereof is coupled to the first terminal of the driving transistor and a second terminal thereof is coupled to the control terminal of the driving transistor.

37. The light-emitting diode apparatus of claim 29, wherein the voltage regulator stops the driving transistor from emitting a light to the light-emitting diode according to a third control signal in a light stop phase.

38. The light-emitting diode apparatus of claim 37, wherein the light stop phase is located after the reset phase, the data writing phase is located after the light stop phase, and the light-emitting phase is located after the data writing phase.

39. The light-emitting diode apparatus of claim 29, wherein the light-emitting diode comprises an organic light-emitting diode.
